(19) United States
(12) Patent Application Publication
(10) Pub. No.: US 2013/0288010 A1
(43) Pub. Date: Oct. 31, 2013

(54) STRENGTHENED GLASS ARTICLE HAVING SHAPED EDGE AND METHOD OF MAKING

(71) Applicants: Ravindra Kumar Akarapu, Painted Post, NY (US); Michael Patrick Donovan, Painted Post, NY (US); Aize Li, Painted Post, NY (US)

(72) Inventors: Ravindra Kumar Akarapu, Painted Post, NY (US); Michael Patrick Donovan, Painted Post, NY (US); Aize Li, Painted Post, NY (US)

(21) Appl. No.: 13/833,469

(22) Filed: Mar. 15, 2013

Related U.S. Application Data
(60) Provisional application No. 61/639,389, filed on Apr. 27, 2012.

(51) Int. Cl. C03C 15/00; B24B 9/10

(52) U.S. Cl. CPC C03C 15/00; B24B 9/10
USPC 428/157; 428/410; 428/192; 65/31; 451/44

(57) ABSTRACT

A strengthened glass sheet or article having an edge profile that provides improved edge strength, particularly when the strengthened glass sheet is subjected to a four point bend test, and a method of making a glass sheet having such an edge. The edge is formed by cutting or other separation methods and then ground to a predetermined profile such as a pencil or bullet profile, a bull nose profile, or the like. In some embodiments, the edge is polished and/or etched following grinding to reduce flaw size.

This application claims the benefit of priority under 35 U.S.C. §119 of U.S. Provisional Application Ser. No. 61/639,389 filed on Apr. 27, 2012 the content of which is relied upon and incorporated herein by reference in its entirety.

### BACKGROUND

The disclosure relates to a strengthened glass sheet having a cut edge. More particularly, the disclosure relates to a strengthened glass sheet having a cut edge that is shaped.

With increasing demand for high strength glass in many fields, such as electronic communication and entertainment devices, vehicle window glass, computers, and the like, a constant effort is being made to improve the quality of the glass surface.

Due to the presence of flaws on surfaces, glass fails under tension. Ion exchange has been used to improve glass surface strength. In the ion exchange process, smaller ions in or near the surface of the glass are replaced by larger ions of the same valence. The advantage of the ion exchange process is that multiple sheets of glass may be simultaneously processed and strengthened.

In many applications, the ion exchange process is carried out at temperatures ranging from about 350° C. to about 500° C. to create surface layers under compressive stress and an inner region under tensile stress. In some applications, a mother sheet (i.e., a sheet of glass that is later to be divided into multiple pieces for final use) is ion exchanged before being cut or otherwise separated into smaller pieces. For integrated touch windows or screens, for example, ion exchange is followed by deposition of conductive indium tin oxide (ITO) patterns on the surface of the mother sheet and the glass is then cut into component pieces. Although the presence of an ion exchanged layer strengthens the major glass surfaces, the glass is still susceptible to failure at relatively low loads due to exposure of the inner tensile region at the edges formed by separation or cutting, resulting in the weakening of the edge, as determined by four point bend strength measurements.

In one approach, chemical etching with pure hydrofluoric acid (HF) or HF-based acid blends is used to increase the strength of edges formed by cutting/separation of ion exchanged sheets or for further improvement of glass surface strength following ion exchange. The chemical etching process significantly enhances glass strength by effectively reducing flaw size and blunting flaw tips. However, chemical etching methods pose risks to personal safety and generate large quantity of chemical waste.

### SUMMARY

The present disclosure provides a strengthened glass sheet or article having an edge profile that provides improved edge strength, particularly when the strengthened glass sheet is subjected to a four point bend test, and a method of making a glass sheet having such an edge. The edge is formed by cutting or other separation methods and then grinding the edge to a predetermined profile such as a pencil profile (e.g., θ=135°), a bull nose (e.g., θ=126°) profile, or the like. In some embodiments, the edge is polished and/or etched following grinding to reduce flaw size.

Accordingly, one aspect of the disclosure is to provide a strengthened glass sheet. The strengthened glass sheet comprises a first surface and a second surface joined by at least one edge, wherein each of the first surface and the second surface are under a compressive stress; at least one edge joining the first surface and the second surface, wherein the at least one edge forms an angle θ with at least one of the first surface and the second surface, wherein 90°<θ<180°, and wherein a portion of the at least one edge is under a second compressive stress. The strengthened glass sheet also includes a central region between the first surface and the second surface, wherein the central region is under a tensile stress, and wherein the strengthened glass sheet has a four point bend strength of at least about 350 MPa and, in some embodiments, in a range from about 350 MPa to about 700 MPa.

Another aspect of the disclosure is to provide a method of making a strengthened glass sheet. The method comprises providing a strengthened glass sheet having a first surface, a second surface, and a central region between the first surface and the second surface, wherein each of the first surface and the second surface are under a compressive stress and the central region is under a tensile stress; and forming an edge joining the first surface and the second surface, wherein a portion of the edge is under a second compressive stress, wherein the at least one edge forms an angle θ with at least one of the first surface and the second surface, wherein 90°<θ<180°, and wherein the strengthened glass sheet has a four point bend strength of at least about 350 MPa.

These and other aspects, advantages, and salient features will become apparent from the following detailed description, the accompanying drawings, and the appended claims.

### BRIEF DESCRIPTION OF THE DRAWINGS

FIG. 1 is a schematic perspective view of an edge formed after cutting an ion exchanged glass sheet from a larger ion exchanged glass sheet;

FIG. 2a is a schematic perspective view of a glass sheet and the boundary conditions used in the two dimensional plane strain 2D model;

FIG. 2b is a schematic cross-sectional view of a glass sheet and the boundary conditions used in the two dimensional plane strain 2D model;

FIG. 3 is plot of the stress state inside the ion exchanged glass sheet and the cut edge of the sheet;

FIG. 4 is a plot of the stress state on the surface of the glass sheet;

FIG. 5 is a plot of the principal stress state in the XY plane perpendicular to both the surface and cut face of an ion exchanged glass sheet;

FIGS. 6a-f are plots of the principal stress for different edge shapes;

FIGS. 7a and 7b are schematic representations showing the probable interaction of cracks introduced due to grinding and tensile stress zone in an ion exchanged glass sheet;

FIG. 8 is a Weibull plot showing the effect of edge shape on edge strength for ion exchanged glass sheets having an edge was not etched; and

FIG. 9 is a Weibull plot showing the effect of edge shape on edge strength for ion exchanged glass sheets etched with a HF/HCl solution.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass” and “glasses” includes both glasses and glass ceramics. The terms “glass article” and “glass articles” are used in their broadest sense to include any object made wholly or partly of glass and/or glass ceramic. As used herein, the term “cutting” refers to cutting or separation of a glass article by those means known in the art including, but not limited to, cutting wheels or blades, mechanical scoring and breaking, partial or complete separation by irradiation with a laser, or the like.

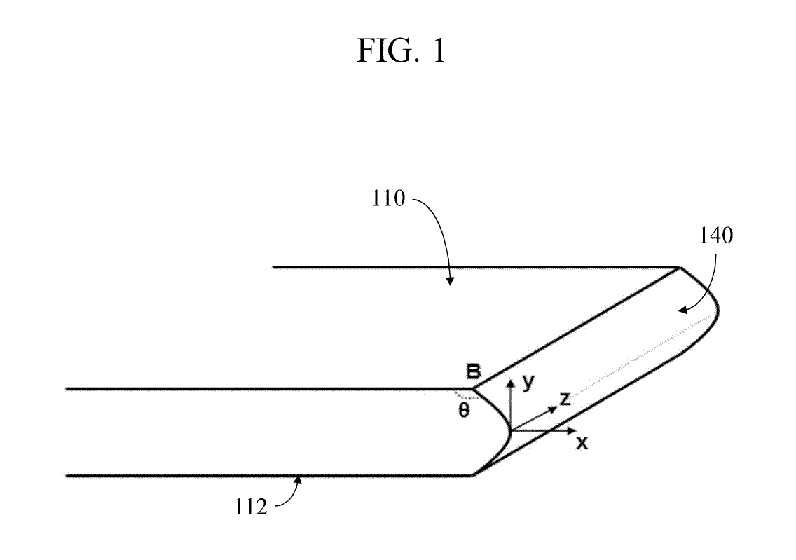

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

With increasing demand for high strength glass in many fields, such as electronic communication and entertainment devices, vehicle window glass, computers, and the like, a constant effort is being made to improve the quality of the surface of such glass articles. In particular, increasing glass strength as well as reducing the variation in strength have been targeted. It is widely known in the art that glass fails under tension, due to the presence of flaws on surfaces. Fire polishing has historically been used to heal such flaws and increase glass strength. However, this technique can only accommodate a single piece of glass at a time and the actual enhancement of strength is limited.

More recently, ion exchange has been used to improve glass surface strength. In the ion exchange process, smaller ions in or near the surface of the glass are replaced by larger ions of the same valence. For practical purposes, the ions are monovalent metal cations such as the alkali metal ions, silver, or the like. Ion exchange takes place by bringing the surface of the glass into contact with an ion exchange medium such as, for example, a molten salt bath containing the larger ion. For example, smaller Li⁺ ions residing in a glass surface may be exchanged with larger Na⁺ ions in an ion exchange medium, Na⁺ ions in the glass may be replaced with K⁺ ions in the ion exchange medium, and so on. The replacement of small ions in the glass with larger ones creates a compressive stress at and near the surface, causing closing of some microflaws on the glass surface and strengthening of the surface. The advantage of the ion exchange process is that multiple sheets of glass may be simultaneously processed/strengthened.

In many applications, the ion exchange process is carried out at temperatures ranging from about 350° C. to about 500° C. to create surface layers under compressive stress and an inner region under tensile stress. In some applications, a mother sheet (i.e., a sheet of glass that is later to be divided into multiple pieces for final use) is ion exchanged before being cut or otherwise separated into smaller pieces. For integrated touch windows or screens, for example, ion exchange is followed by deposition of conductive indium tin oxide (ITO) patterns on the surface of the mother sheet, and the glass is then cut into component pieces. Although the presence of an ion exchanged layer strengthens the major glass surfaces, the glass is still susceptible to failure at relatively low loads due to exposure of the inner tensile region at the edges formed by separation or cutting, resulting in the weakening of the edge, as determined by four point bend strength measurements.

In one approach, chemical etching with pure hydrofluoric acid (HF) or HF-based acid blends is used to increase the strength of edges formed by cutting/separation of ion exchanged sheets or for further improvement of glass surface strength following ion exchange. The chemical etching process significantly enhances glass strength by effectively reducing flaw size and blunting flaw tips. The drawbacks of the chemical etching method are that personal protective equipment is required when handling HF and large quantities of chemical waste are generated during the process. Seeking a “green” technique to improve glass surface quality is therefore desirable.

In addition to glass strength, a low variation in the strength distribution in the glass is also desired. Controlling the variation of glass strength to be within a small range allows the manufacturing process to be easily controlled and modified and enables a higher yield of glass to be achieved. The strength variation of etched glass is highly dependent on the size of flaws in the glass—particularly on surfaces and edges—before etching. However, etching in itself does not facilitate a reduction of the variation of strength.

Improving cutting and finishing techniques to produce a uniform flaw size may decrease the variation of glass strength throughout the glass sheet and at or near the edge. Disclosed herein is a new chemical-free, low energy method for effectively increasing the four point bend strength of a strengthened glass by tuning the shape of the glass edge. Numerical simulations are used to understand the correlation between edge shape and intrinsic edge strength at the cut edge for a strengthened glass article, thereby adding a family of edge shapes that increases the four point bend strength of a glass article.

The process of cutting a glass sheet or plate from an ion exchanged mother sheet (e.g., a larger glass sheet) results in the formation of a new surface at the cut edge. The internal stresses created by ion exchange are redistributed as the cut edge is formed. Shaping of cut edges allows the stress state at the edge to be manipulated, thus resulting in edges that perform better in horizontal four point bend testing. By so manipulating the residual stresses from chemical strengthening, the applied loads in horizontal four point bending can be increased to overcome the impact of the residual tensile stress. The numerical calculations of the redistributed edge stress correlated the edge shape to its strength and experimental data confirmed the correlation.

By altering the edge shape, the edge strength of cut ion exchanged glass is increased without chemical or thermal treatment or lamination. The variation in strength of the glass article and the cut edge is reduced, as exhibited by an improved Weibull slope. The methods described herein are applicable to glasses of any thickness or composition.

Accordingly, in one aspect, a strengthened glass sheet having a four point bend strength of at least about 350 MPa is provided. The glass sheet may be strengthened by those means known in the art, such as thermal strengthening and chemical strengthening, including, for example, ion exchange. The glass sheet has a thickness, in some embodiments, in a range from about 0.1 mm up to about 3 mm. In other embodiments, the glass has a thickness in a range from about 0.1 mm up to about 2 mm. In some embodiments, the four point bend strength is in a range from about 350 MPa to about 700 MPa. The strengthened glass sheet has a first surface and a second surface joined by at least one edge, wherein each of the first surface and the second surface are under a compressive stress, and a central region between the first surface and the second surface, wherein the central region is under a tensile stress. The at least one edge joins the first surface and the second surface and forms an angle θ with at least one of the first surface and the second surface, wherein 90°<θ<180°. In some embodiments, 90°<θ<150°, in other embodiments, 90°<θ<135° and, in still other embodiments, 90°<θ<120°. A portion of the at least one edge is under a second compressive stress that is less than or equal to the compressive stress of the first or second surfaces.

In some embodiments, the at least one edge is ground to a predetermined profile using those means known in the art. Such predetermined profiles include, but are not limited to, bullnose profiles (e.g., θ=126°), chamfered profiles, pencil profiles (e.g., θ=135°), rounded profiles, elliptical profiles, and the like. For example, the at least one edge may be ground to the predetermined profile by grinding with a 400 grit grinding wheel. Such grinding, while forming the predetermined profile, may create cracks and/or flaws on the surface. In one embodiment, the flaws and/or cracks have a mean flaw size of about 22 μm. In some embodiments, the mean flaw size is in a range from about 0.1 μm up to about 45 μm.

Following grinding to a predetermined profile, the at least one edge may be further polished using those means known in the art. In yet another embodiment, the at least one edge may, after grinding and/or polishing, be etched using a hydrofluoric acid-based etchant to further remove flaws and/or blunt crack tips that may be present on the edge. Non-limiting examples of such etchants and edge treatments are described in U.S. patent application Ser. No. 12/862,096 by Joseph M. Matusick et al., filed on Aug. 24, 2010, and entitled “Method of Strengthening Edge of Glass Article,” the contents of which are incorporated herein by reference in their entirety.

Each of the first and second surfaces of the strengthened glass sheet is under a compressive stress of at least about 500 MPa. The layer of the glass that is under the compressive stress extends from each of the first surface and the second surface into the bulk of the glass to a depth of layer in a range from about 15 μm up to about 70 μm.

The glasses described herein may comprise or consist of any glass that is chemically strengthened by ion exchange. In some embodiments, the glass is an alkali aluminosilicate glass.

In one embodiment, the alkali aluminosilicate glass comprises: from about 64 mol % to about 68 mol % SiO₂; from about 12 mol % to about 16 mol % Na₂O; from about 8 mol % to about 12 mol % Al₂O₃; from 0 mol % to about 3 mol % B₂O₃; from about 2 mol % to about 5 mol % K₂O; from about 4 mol % to about 6 mol % MgO; and from 0 mol % to about 5 mol % CaO; wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)—Al₂O₃≧2 mol %; 2 mol %≦Na₂O—Al₂O₃≦6 mol %; and 4 mol %≦(Na₂O+K₂O)—Al₂O₃≦10 mol %. The glass is described in U.S. Pat. No. 7,666,511 by Adam J. Ellison et al., entitled “Down-Drawable, Chemically Strengthened Glass for Cover Plate,” filed Jul. 27, 2007, and claiming priority to U.S. Provisional Patent Application No. 60/930,808, filed on May 18, 2007, the contents of which are incorporated herein by reference in their entirety.

In another embodiment, the alkali aluminosilicate glass comprises: at least one of alumina and boron oxide, and at least one of an alkali metal oxide and an alkali earth metal oxide, wherein—15 mol %≦(R₂O+R′O—Al₂O₃—ZrO₂)—B₂O₃≦4 mol %, where R is one of Li, Na, K, Rb, and Cs, and R′ is one of Mg, Ca, Sr, and Ba. In some embodiments, the alkali aluminosilicate glass comprises: from about 62 mol % to about 70 mol. % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. The glass is described in U.S. patent application Ser. No. 12/277,573 by Matthew J. Dejneka et al., entitled “Glasses Having Improved Toughness and Scratch Resistance,” filed Nov. 25, 2008, and claiming priority to U.S. Provisional Patent Application No. 61/004,677, filed on Nov. 29, 2008, the contents of which are incorporated herein by reference in their entirety.

In another embodiment, the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %. In certain embodiments, the glass comprises 60-72 mol % SiO₂; 6-14 mol % Al₂O₃; 0-15 mol % B₂O₃; 0-1 mol % Li₂O; 0-20 mol % Na₂O; 0-10 mol % K₂O; 0-2.5 mol % CaO; 0-5 mol % ZrO₂; 0-1 mol % SnO₂; and 0-1 mol % CeO₂, wherein 12 mol %≦Li₂O+Na₂O+K₂O≦20 mol %, and less than 50 ppm As₂O₃. The glass is described in U.S. Pat. No. 8,158,543 by Sinue Gomez et al., entitled “Fining Agents for Silicate Glasses,” filed Feb. 25, 2009, and U.S. patent application Ser. No. 13/495,355 by Sinue Gomez et al., entitled “Silicate Glasses Having Low Seed Concentration,” filed Jun. 13, 2012, both of which claim priority to U.S. Provisional Patent Application No. 61/067,130, filed on Feb. 26, 2008, the contents of which are incorporated herein by reference in their entirety.

In another embodiment, the alkali aluminosilicate glass comprises SiO₂ and Na₂O, wherein the glass has a temperature T_{35 kp} at which the glass has a viscosity of 35 kilo poise (kpoise), wherein the temperature T_{breakdown} at which zircon breaks down to form ZrO₂ and SiO₂ is greater than T_{35 kp}. In some embodiments, the alkali aluminosilicate glass comprises: from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO. The glass is described in U.S. patent application Ser. No. 12/856,840 by Matthew J. Dejneka et al., entitled “Zircon Compatible Glasses for Down Draw,” filed Aug. 10, 2010, and claiming priority to U.S. Provisional Patent Application No. 61/235,762, filed on Aug. 29, 2009, the contents of which are incorporated herein by reference in their entirety.

In another embodiment, the alkali aluminosilicate glass comprises at least 50 mol % SiO₂ and at least one modifier selected from the group consisting of alkali metal oxides and alkaline earth metal oxides, wherein [(Al₂O₃ (mol %)+B₂O₃ (mol %))/(Σalkali metal modifiers(mol %))]>1. In some embodiments, the alkali aluminosilicate glass comprises: from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. The glass is described in U.S. patent application Ser. No. 12/858,490 by Kristen L. Barefoot et al., entitled “Crack And Scratch Resistant Glass and Enclosures Made Therefrom,” filed Aug. 18, 2010, and claiming priority to U.S. Provisional Patent Application No. 61/235,767, filed on Aug. 21, 2009, the contents of which are incorporated herein by reference in their entirety.

In another embodiment, the alkali aluminosilicate glass comprises SiO₂, Al₂O₃, P₂O₅, and at least one alkali metal oxide (R₂O), wherein 0.75≦[(P₂O₅ (mol %)+R₂O(mol %))/M₂O₃ (mol %)]≦1.2, where M₂O₃=Al₂O₃+B₂O₃. In some embodiments, the alkali aluminosilicate glass comprises: from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O; and, in certain embodiments, from about 40 to about 64 mol % SiO₂; from 0 mol % to about 8 mol % B₂O₃; from about 16 mol % to about 28 mol % Al₂O₃; from about 2 mol % to about 12% P₂O₅; and from about 12 mol % to about 16 mol % R₂O. The glass is described in U.S. patent application Ser. No. 13/305,271 by Dana C. Bookbinder et al., entitled “Ion Exchangeable Glass with Deep Compressive Layer and High Damage Threshold,” filed Nov. 28, 2011, and claiming priority to U.S. Provisional Patent Application No. 61/417,941, filed Nov. 30, 2010, the contents of which are incorporated herein by reference in their entirety.

In still other embodiments, the alkali aluminosilicate glass comprises at least about 4 mol % P₂O₅, wherein (M₂O₃ (mol %)/RₓO (mol %))<1, wherein M₂O₃═Al₂O₃+B₂O₃, and wherein RₓO is the sum of monovalent and divalent cation oxides present in the alkali aluminosilicate glass. In some embodiments, the monovalent and divalent cation oxides are selected from the group consisting of Li₂O, Na₂O, K₂O, Rb₂O, Cs₂O, MgO, CaO, SrO, BaO, and ZnO. In some embodiments, the glass comprises 0 mol % B₂O₃. The glass is described in U.S. patent application Ser. No. 13/677,805 by Timothy M. Gross, entitled “Ion Exchangeable Glass with High Crack Initiation Threshold,” filed Nov. 15, 2012, and claiming priority to U.S. Provisional Patent Application No. 61/560,434, filed Nov. 16, 2011, the contents of which are incorporated herein by reference in their entirety.

In still another embodiment, the alkali aluminosilicate glass comprises at least about 50 mol % SiO₂ and at least about 11 mol % Na₂O, and the compressive stress is at least about 900 MPa. In some embodiments, the glass further comprises Al₂O₃ and at least one of B₂O₃, K₂O, MgO and ZnO, wherein—340+27.1.Al₂O₃-28.7.B₂O₃+15.6.Na₂O-61.4.K₂O+8.1.(MgO+ZnO)≧0 mol %. In particular embodiments, the glass comprises: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO. The glass is described in U.S. patent application Ser. No. 13/533,298 by Matthew J. Dejneka et al., entitled “Ion Exchangeable Glass with High Compressive Stress,” filed Jun. 26, 2012, and claiming priority to U.S. Provisional Patent Ion Application No. 61/503,734, filed Jul. 1, 2011, the contents of which are incorporated herein by reference in their entirety.

In other embodiments, the alkali aluminosilicate glass comprises at least about 50 mol % SiO₂; at least about 10 mol % R₂O, wherein R₂O comprises Na₂O; Al₂O₃, wherein—0.5 mol %≦Al₂O₃ (mol %)-R₂O (mol %)≦2 mol %; and B₂O₃, and wherein B₂O₃ (mol %)-(R₂O (mol %)-Al₂O₃ (mol %))≧4.5 mol %. In particular embodiments, the glass comprises at least about 50 mol % SiO₂, from about 12 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO, ZnO, or combinations thereof, wherein 0 mol %≦MgO≦6 and 0≦ZnO≦6 mol %; and, optionally, at least one of CaO, BaO, and SrO, wherein 0 mol %≦CaO+SrO+BaO≦2 mol %. The glass is described in U.S. Provisional Patent Application No. 61/653,485 by Matthew J. Dejneka et al., entitled “Ion Exchangeable Glass with High Damage Resistance,” filed May 31, 2012, the contents of which are incorporated by reference in their entirety.

In other embodiments, the alkali aluminosilicate glass comprises at least about 50 mol % SiO₂; at least about 10 mol % R₂O, wherein R₂O comprises Na₂O; Al₂O₃, wherein Al₂O₃(mol %)<R₂O (mol %); and B₂O₃, and wherein B₂O₃ (mol %)-(R₂O (mol %)-Al₂O₃ (mol %))≧3 mol %. In certain embodiments, the glass comprises at least about 50 mol % SiO₂, from about 9 mol % to about 22 mol % Al₂O₃; from about 3 mol % to about 10 mol % B₂O₃; from about 9 mol % to about 20 mol % Na₂O; from 0 mol % to about 5 mol % K₂O; at least about 0.1 mol % MgO, ZnO, or combinations thereof, wherein 0≦MgO≦6 mol % and 0≦ZnO≦6 mol %; and, optionally, at least one of CaO, BaO, and SrO, wherein 0 mol %≦CaO+SrO+BaO≦2 mol %. In certain embodiments, the glass has a zircon breakdown temperature that is equal to the temperature at which the glass has a viscosity in a range from about 30 kPoise to about 40 kPoise. The glass is described in U.S. Provisional Patent Application No. 61/653,489 by Matthew J. Dejneka et al., entitled “Zircon Compatible, Ion Exchangeable Glass with High Damage Resistance,” filed May 31, 2012, the contents of which are incorporated by reference in their entirety.

In some embodiments, the alkali aluminosilicate glasses described hereinabove are substantially free of (i.e., contain 0 mol % of) of at least one of lithium, boron, barium, strontium, bismuth, antimony, and arsenic.

In some embodiments, the alkali aluminosilicate glasses described hereinabove are down-drawable by processes known in the art, such as slot-drawing, fusion drawing, re-drawing, and the like, and has a liquidus viscosity of at least 130 kilopoise.

In another aspect, a method of making the strengthened glass sheet described hereinabove is provided. In a first step, the method includes providing a strengthened glass sheet having a first surface and a second surface under compressive stress and a central region between the first surface and the second surface, wherein the central region is under a tensile stress, or central tension. In some embodiments, the step of providing the strengthened glass sheet includes down-drawing a glass sheet by those means known in the art such as, but not limited to, slot- and fusion-draw processes. Alternatively, the glass sheet may be provided by float, casting, molding, or other means known in the art. The step of providing the strengthened glass sheet may further include strengthening the glass sheet by chemical or thermal means such as, but not limited to, thermal tempering, ion exchange, or the like. The glass may be strengthened to obtain a maximum compressive stress in a range from about 400 MPa to about 1000 MP. In some embodiments, the glass is ion exchanged to obtain a compressive of at least 500 MPa. The layer under compressive stress extends from each of the first and second surfaces to a depth of layer in a range from about 15 μm to about 70 μm.

At least one edge joining the first and second surfaces of the strengthened glass sheet is then formed. A portion of the at least one edge is under a second compressive stress. The second compressive stress is less and or equal to the compressive stress of the first surface and the second surface. In some embodiments, a second portion of the at least one edge is under a tensile stress that is less than or equal to the tensile stress of the central region.

In some embodiments, the step of forming the at least one edge includes forming an edge having a predetermined profile such as, but not limited to, those profiles described hereinabove, including bullnose, rounded, pencil or bullet-nosed, and elliptical profiles. Forming the edge may include grinding the edge to obtain the predetermined profile, followed by polishing the edge and/or etching the edge with a hydrofluoric acid-based etchant. The at least one edge forms an angle 0 with at least one of the first surface and the second surface, wherein 90°<θ<180°. In some embodiments, 90°<θ<150°, in other embodiments, 90°<θ<135° and, in still other embodiments, 90°<θ<120°. The at least one edge formed to the desired profile contains a plurality of flaws having a mean size of about 22 μm. Following the formation of the predetermined profile on the edge by grinding and optional polishing and/or etching, the strengthened glass sheet has a four point bend strength of at least about 350 MPa. In some embodiments, the four point bend strength is in a range from about 350 MPa to about 700 MPa.

Ion exchange processes create biaxial compression on the surfaces of a glass plate and biaxial tension in the center of the plate. When an ion exchanged glass plate is cut or otherwise separated by those techniques known in the art such as, mechanical scoring and breaking, laser separation, or the like, residual stress is redistributed near the edge formed by such cutting. The redistributed edge stress state is a factor that affects the edge strength in a horizontal four point bend test. Numerical modeling and/or analytical methods have been used to compute the redistributed edge stress state and compare the edge stress with respect to glass composition, thickness, and edge shape. An edge that is formed after cutting a piece from a larger ion exchanged glass sheet is schematically shown in FIG. 1. Attaching an XYZ coordinate system to the glass sheet, cut edge 140 is perpendicular to the XY plane, whereas surfaces 110, 112 are parallel to the YZ plane and the Y direction corresponds to the thickness of the glass plate.

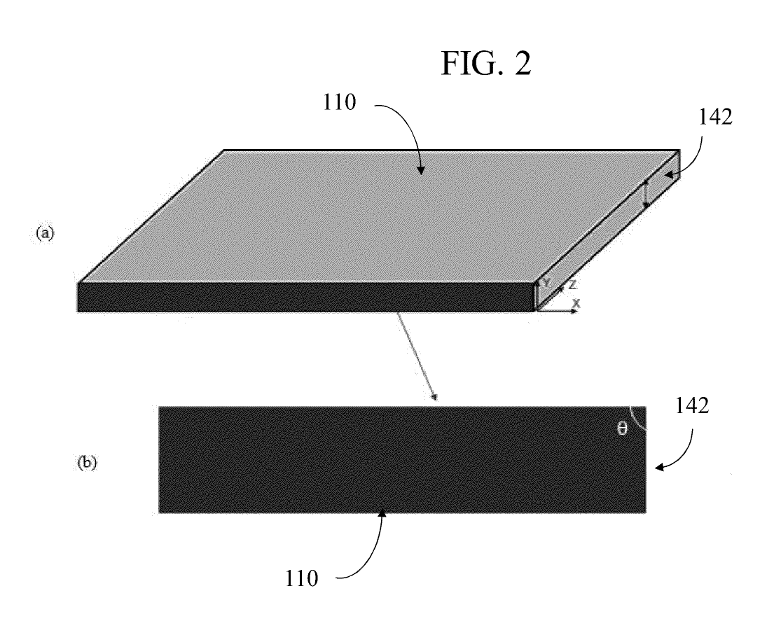

The stress state at the edge 140 was calculated using a two dimensional (2D) plane strain model. The initial model was developed to calculate the edge stress state for a 1.1 mm thick sheet of alkali aluminosilicate glass (Gorilla® Glass, manufactured by Corning Inc.) having a straight edge 142 and surface 110. The numerical simulations take advantage of ¼ symmetry resulting in a domain shown in FIGS. 2a and 2b. FIGS. 2a and 2b also show the boundary conditions used in the model.

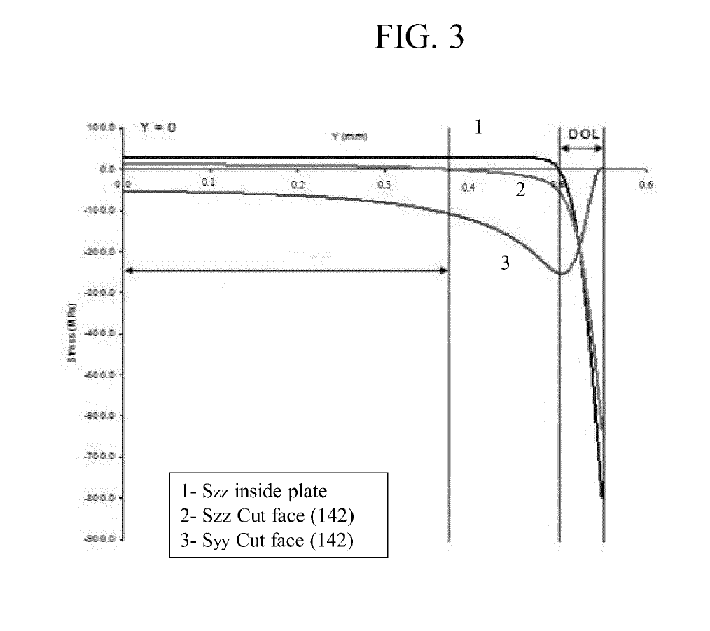

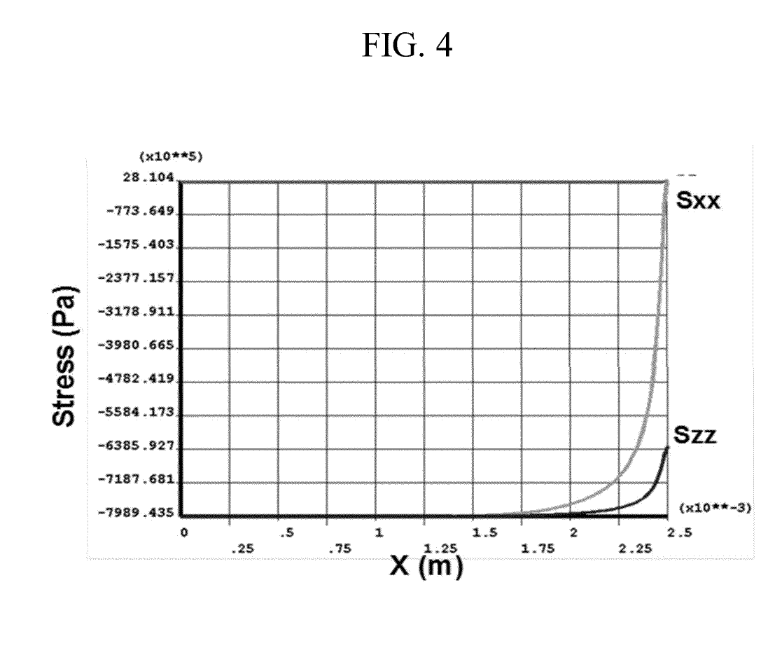

The stress state inside the ion exchanged glass plate 100 and the cut edge (or face) 140 are plotted in FIG. 3. The features of the edge stress state include a tensile stress in the Z direction experienced by a portion of the cut edge 142. The glass surface 110 is in biaxial compression in regions far away from a straight cut edge 140. Within a distance equal to thickness of glass plate, however, the surfaces 110 are not in biaxial compression near the cut edge, as shown in FIG. 4, which is a plot of the stress state on the surface of the glass.

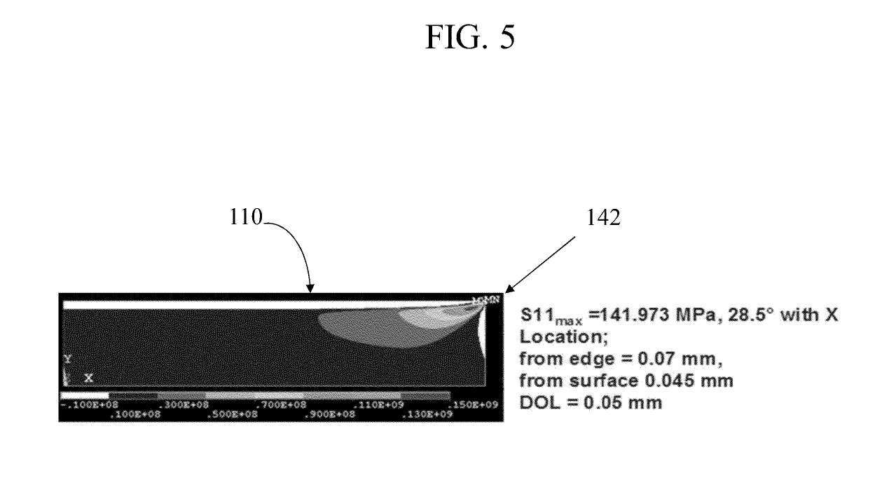

The principal stress state in the XY plane perpendicular to both surface 110 and cut face 142 of the ion exchanged glass plate is shown FIG. 5. A tensile principal stress zone develops in the XY plane near the intersection of the surface 110 and cut face. The magnitude of the maximum value of this principal stress in the XY plane is greater than the central tension (i.e., the maximum tensile stress CT in the glass before cutting) and is located close to the surface 110 and cut face 142.

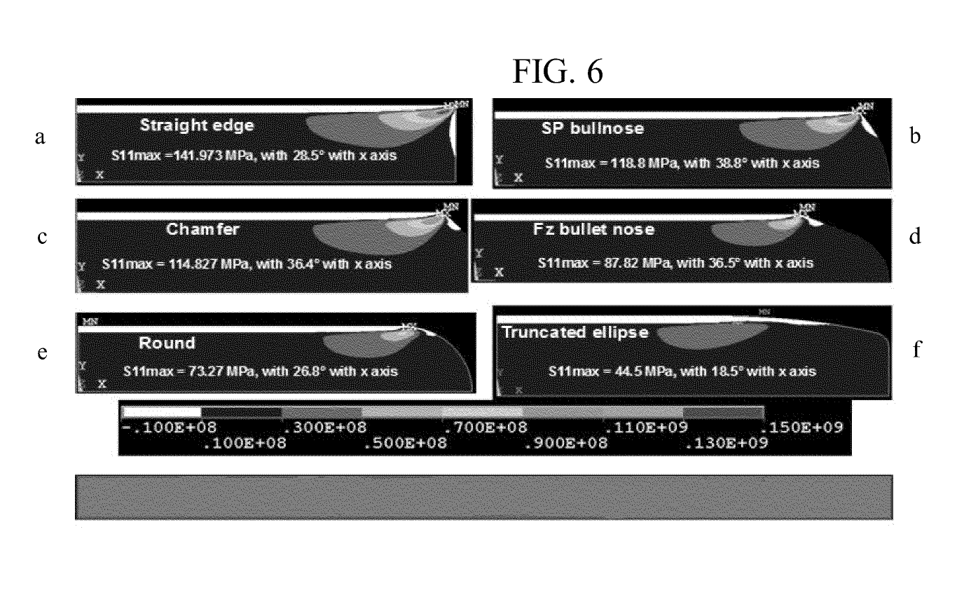

Edge stress was calculated for different edge shapes/profiles, including: a) a straight profile; b) a bullnose (“SP bull nose (θ=126°)” in FIG. 6) profile; c) a chamfer; d) a pencil or bullet (e.g., θ=135°) nose (“FZ bullet nose” in FIG. 6) profile, e) a round profile; and f) a truncated ellipse. Principal stress plots for the different edge shapes are shown in FIG. 6. Simulation was performed for a 1.1 mm thick sheet of Gorilla® Glass. The greater the angle θ (FIG. 1) between the surface 110 and the cut face 142, the lower the magnitude of maximum principal stress.

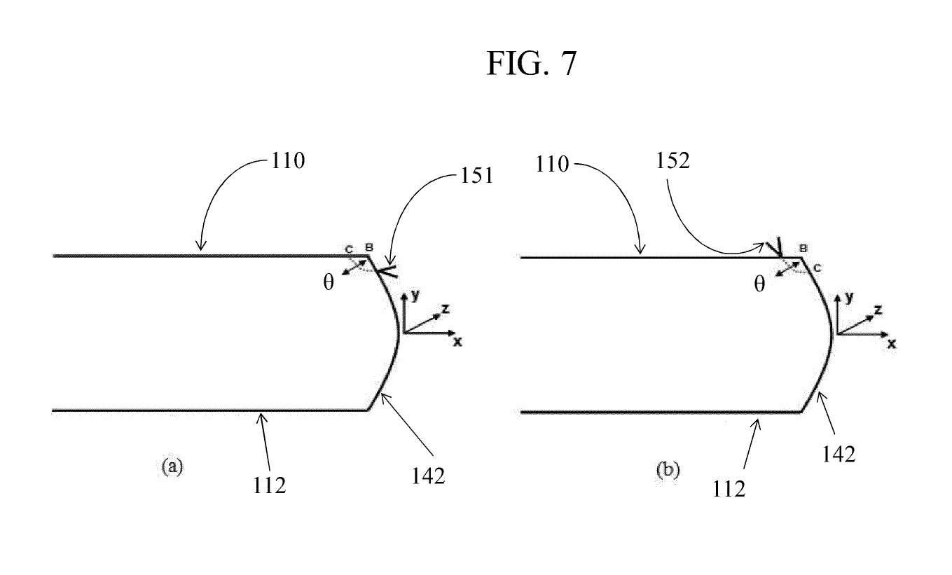

Newly formed edges of the strengthened glass plate that was cut from a mother sheet were ground to the required shape and then etched using a mixture of HF and HCl acids. The bottom surface of the glass experiences a tensile stress directed along the length of the edge in horizontal four point bend tests. According to the coordinate system shown in FIG. 1, the bottom of the cut glass plate experiences stress in the Z direction. The tensile stress zone present near the intersection of surface 110, 112 and edge 142 is in a plane perpendicular to the bending stress and therefore does not add to and increase the magnitude of the applied stress. Instead, this tensile stress zone may interact with cracks introduced during machining to produce strength-limiting flaws. The probable interaction of cracks introduced due to grinding and tensile stress zone is schematically shown in FIGS. 7a and 7b. As shown in FIGS. 7a and 7b, cracks 151, 152 that are introduced at the corner during grinding interact with the tensile stress and may result in chipping of glass in this region. The end of this chipping event, designated as location “C” in FIGS. 7a and 7b, may result in the formation of twist hackles, which result in strength limiting flaws—which may result from cutting and/or grinding—oriented perpendicular to the applied bending stress. Thus, the shape of the edge may be correlated to the strength exhibited in horizontal four point bend testing. For example, the magnitude of tensile stress at the intersection between surface 110 (or 112) and edge 140 (or 142) is higher for a straight edge profile (a in FIG. 6; θ=90°) in comparison to a bull nose edge/profile (b in FIG. 6; θ=126°). Similarly, the magnitude of the tensile stress for a bull nose edge/profile is higher in comparison to that of a pencil or bullet edge/profile (d in FIG. 6; θ=135°). Based on this analysis, the strength of a pencil or bullet edge profile should be greater than that of a bull nose edge/profile, and the strength of a bull nose edge/profile should be greater than that of a straight edge profile.

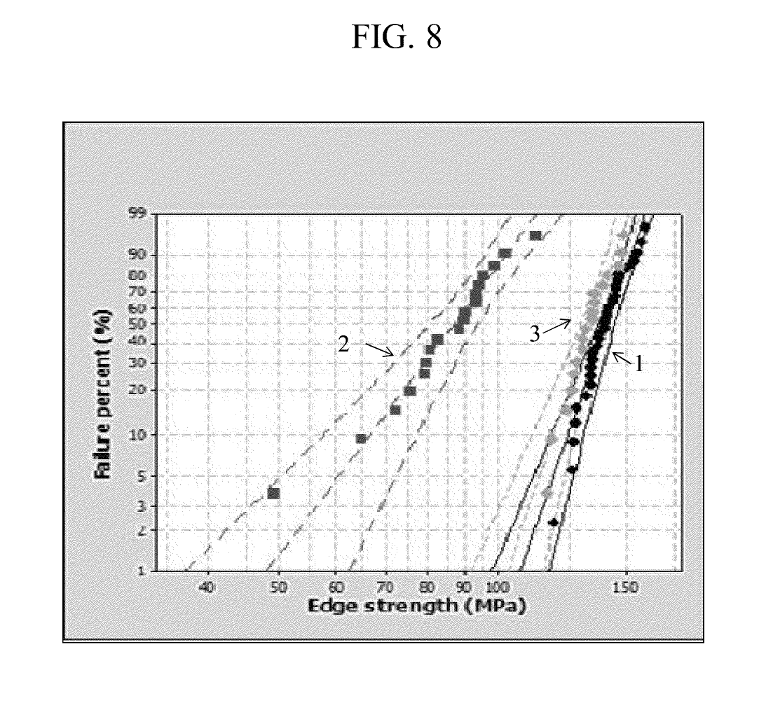

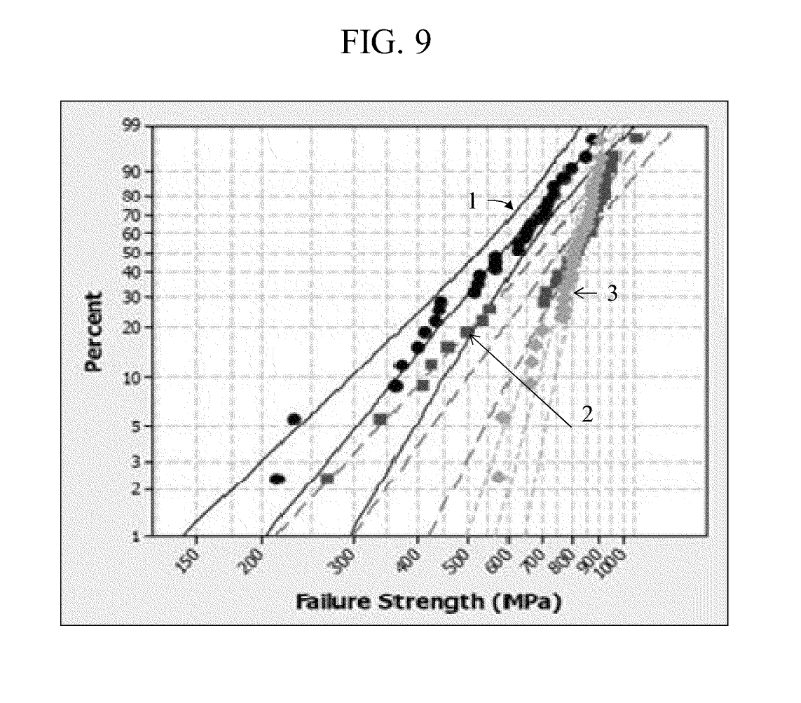

Strength tests were performed to assess the effect of the shape of the ground edge on edge strength, and Weibull plots constructed from the test results are shown in FIGS. 8 and 9. FIG. 8 is a Weibull plot from a strength test showing the effect of ground edge on edge strength for samples having a ground bull nose (θ=126°) edge (line 1 in FIG. 8); a flat (θ=90°) edge (line 2 in FIG. 8); and a pencil (θ=135°) edge (line 3 in FIG. 8) where the edge was not etched. The ground edges were formed on 1.1 mm ion exchanged Gorilla® Glass using a 400 grit grinding wheel. FIG. 9 is a Weibull plot showing the effect of edge shape on edge strength for flat (θ=90°) edge (line 1 in FIG. 9); bull nose (θ=126°) edge (line 2 in FIG. 9); and pencil (θ=135°) edge (line 3 in FIG. 9) samples in which the edge was ground and etched using a 5% HF/5% HCl solution for 32 minutes. The ground edges were formed on 1.1 mm ion exchanged Gorilla® Glass using a 400 grit grinding wheel and the edges were etched after grinding. The experimental data indicate that edge shape/profile allows stress state to be manipulated and controlled at the edge of the glass sheet, resulting in edges that perform better in horizontal four point bend tests.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A strengthened glass sheet, the strengthened glass sheet comprising:
a. a first surface and a second surface joined by at least one edge, wherein each of the first surface and the second surface are under a compressive stress;
b. at least one edge joining the first surface and the second surface, wherein the at least one edge forms an angle 0 with at least one of the first surface and the second surface, wherein 90°≦θ≦180°), and wherein a portion of the at least one edge is under a second compressive stress; and
c. a central region between the first surface and the second surface, wherein the central region is under a tensile stress, and wherein the strengthened glass sheet has a four point bend strength of at least about 350 MPa.

2. The strengthened glass sheet of claim 1, wherein the at least one edge is ground and, optionally, polished.

3. The strengthened glass sheet of claim 2, wherein the at least one edge has a plurality of flaws, the flaws having a mean size of about 22 μm.

4. The strengthened glass sheet of claim 2, wherein the at least one edge is etched.

5. The strengthened glass sheet of claim 1, wherein the second compressive stress is less than or equal to the compressive stress of the first surface and the second surface.

6. The strengthened glass sheet of claim 1, wherein the compressive stress extends from each of the first surface and the second surface to a depth of layer in a range from about 15 μm up to about 70 μm into the glass.

7. The strengthened glass sheet of claim 1, wherein the strengthened glass sheet comprises an alkali aluminosilicate glass.

8. The strengthened glass sheet of claim 1, wherein the at least one edge has a bullnose profile or a pencil profile.

9. The strengthened glass sheet of claim 1, wherein the strengthened glass sheet is ion exchanged.

10. A method of making a strengthened glass sheet, the method comprising:
a. providing a strengthened glass sheet, the strengthened glass sheet having a first surface and a second surface and a central region between the first surface and the second surface, wherein each of the first surface and the second surface are under a compressive stress and the central region is under a tensile stress; and
b. forming an edge joining the first surface and the second surface, wherein a portion of the edge is under a second compressive stress, wherein the at least one edge forms an angle 0 with at least one of the first surface and the second surface, wherein 90°≦θ≦180°, wherein the strengthened glass sheet has a four point bend strength of at least about 350 MPa.

11. The method of claim 10, wherein forming the edge joining the first surface and the second surface comprises forming a predetermined edge profile by at least one of grinding the edge and polishing the edge.

12. The method of claim 11, further comprising etching the edge following grinding the edge.

13. The method of claim 11, wherein the predetermined edge profile is one of a bullnose profile and a pencil profile.

14. The method of claim 11, further comprising etching the edge after forming the predetermined edge profile.

15. The method of claim 10, wherein the compressive stress is at least about 400 MPa.

16. The method of claim 10, wherein the compressive stress extends from each of the first surface and the second surface to a depth of layer of at least 15 μm into the glass.

17. The method of claim 10, wherein the second compressive stress is less than the compressive stress is less than or equal to the compressive stress of the first surface and the second surface.

18. The method of claim 10, wherein the strengthened glass sheet comprises an alkali aluminosilicate glass.
